(19) United States
(12) Patent Application Publication
(10) Pub. No.: US 2004/0074373 A1
(43) Pub. Date: Apr. 22, 2004

(54) Metal components for a stringed instrument

(76) Inventor: Takao Goto, Gunma (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/468,848

(22) PCT Filed: Mar. 5, 2001
(86) PCT No.: PCT/JP02/01669

(51) Int. Cl. G10D 3/00

(52) U.S. Cl. 84/452 R

(57) ABSTRACT

Metal components for a stringed instrument which slide against the string and other components are provided. By providing at least those portions which slide against other components with a lubricating solid coating including a mixture of nickel and a fluorine resin, rusting and corrosion caused by perspiration adhering to those components is prevented. Also, frictional resistance due to the components sliding against each other is reduced.

### BACKGROUND OF THE INVENTION

1. Technical Field

The present invention relates to metal components for a stringed instrument such as a guitar which make metallic contact with the strings, and with other components, which contact the metal components, and the like. The present invention also relates to a technique for preventing rusting and corrosion of the metal components and also for reducing frictional resistance due to the components sliding against each other, thus maintaining smooth operation thereof.

2. Background Art

In an electric guitar which includes a tremolo unit, by causing the tremolo arm to move towards and away from the guitar body, the tremolo unit which fixes the base end portion of the string is caused to incline in the direction of the neck of the guitar, or in the direction opposite thereto. As a result, the tensions of all of the strings are changed, and the pitch is changed (choking is carried out) during playing. Many metal components are used in forming this type of electric guitar.

First, there is a saddle which supports the strings and sets the tension thereof, provided between the nut at the front end portion of the neck and the string. There is also a bridge which supports the saddle. In addition, there is a tailpiece which fixes the string ball provided at the base end of the strings. The bridge and the tailpiece form the tremolo unit which is also provided on the base plate. However, the bridge and the tailpiece may be attached separately to the guitar body, and be provided so as to be unmovable. Furthermore, the front-back direction position of the saddle may be changed, thereby carrying out fine tuning and adjustment of tone. Also, a mechanism for changing the height of the saddle and thereby adjusting the height of the string may also be attached to the bridge. Many metal components are used in forming this type of a mechanism also. Generally, these types of metal components are subjected to surface processing such as plating or an alumite process so that they are esthetically pleasing, and also in order to prevent rusting.

In addition, a guitar is often played while holding the little-finger tip of the base of the right hand on the saddle, thereby muting the low sounding strings. When the guitar is played in this manner, the perspiration of the player often adheres to the saddle or to the peripheral metal components. As a result, these metal components rust very quickly. Specifically, if the saddle which supports the strings rusts, when the tremolo arm is moved away, the strings cannot be completely returned to the original position because there is a large amount of frictional resistance between the strings and saddle. As a result, the string tension between the nut and the saddle changes, and there is a problem in that the guitar goes out of tune. Specifically, when the tremolo arm reaches the guitar body side, the string moves toward the body and the string slackens, causing the pitch to become lower. If the tremolo arm is subsequently moved away, the tremolo unit returns to the original position and the string moves toward the saddle. However, because the string does not slide smoothly on the saddle, the string tension is reduced between the nut and the saddle, and the tension between the saddle and the tailpiece is increased. Since the sound of the guitar is determined by the string tension between the nut and the saddle, the pitch discrepancy is such that the pitch is lower than it was when tuning was initially carried out. It is to be noted that when the guitar is choked so that the pitch increases, the pitch discrepancy is opposite to that described above, and thus the pitch is higher than when the guitar was tuned initially.

If the pitch changes in this manner during performance, this can be a serious problem. The problem is particularly serious because this defect of the guitar is caused by the player perspiring during performance, and this is unavoidable. In addition, during performance, perspiration can easily adhere to not only the saddle, but also to other metal components such as the block which forms the mechanism for adjusting the string height and the string length. If these metal components rust, it becomes difficult for them to move, and thus adjustment becomes difficult. In the worst case, the metal components become unmovable due to rust.

In addition to the problems of the moving portions which are caused by rusting as a result of perspiration being adhered to the metal components, even when there is no rusting, because there is intense rubbing of the string and other related components, sometimes wearing progresses very rapidly and surface roughening or wear adhesion of the metal occurs. As a result, the components cannot move smoothly against each other, and this may decrease the quality of performance and hinder proper tuning. For example, even in the guitar that is not equipped with a tremolo unit, choking is carried out by the sliding the finger which presses the string on the same fret. This type of choking may be one in which the pitch is increased over whole tone. When this type of choking is carried out, there is forceful sliding of the strings on the saddle and this promotes wear of the saddle. In addition, even if choking is not carried out, when the guitar is tuned, because the string which is brought into contact with the saddle with a strong force moves, wear of the saddle is promoted. Also, when wear of the saddle is promoted and surface roughening and the like occurs, problems occur such as vibration of the sounds during performance and the instrument goes out of tune because the strings do not completely return to their original position after choking due to great frictional resistance of the strings. These types of problems also occur for metal components other than the saddle which slide against the strings.

For example, the nut may be made of metal, and a metallic string press (tension bar or retainer bar) for pressing the string from above may be provided between the nut and the peg. This string press depresses down the string in the middle of the space between the nut and the peg and prevents vibration of the strings. Also, when wear of the nut and the string press progresses, vibration occurs during performance, due to surface roughening and the like. In addition, when frictional resistance of the nut and the string press increases, vibration occurs during performance due to surface roughening and the like. The frictional resistance of the nut and the string also increases, and thus after choking, the string does not return completely to its original position. It is to be noted that if the saddle and the nuts, and the string press are coated with a lubricant such as oil or grease, the progression of the wear is controlled to some extent. However, if the resulting grease deposit on the wooden components of the guitar is taken into consideration, this type of method will not be used.

In addition, there is the problem of the inclining mechanism of the tremolo unit which is caused by the progress of the wear. For example, a knife edge is formed at the edge of the front end of the base plate of the tremolo unit, which is a support point at the time when the tremolo unit is inclined. A support member is mounted at the guitar body which engages with the knife edge and supports the knife edge so that it can be inclined. It is to be noted that the support member is typically a stud bolt (or a machine screw) which is mounted to the body and the portion directly beneath the head portion of the bolt engages with the knife edge. There are also cases in which the portion directly beneath the head portion is subjected to grinding so as to have a V-shaped configuration. On the other hand, a block which passes through the back of the body is mounted at the rear end portion of the base plate, and the front end portion of the block can be pulled by a coil spring which is attached to the body. As a result, the tremolo unit receives a force in the direction of the forward incline due to string tension, and also receives a force in the direction of the backward incline due to the elastic force of the coil spring, and tuning is carried out when both forces are counterbalanced. In addition, in the case where tuning is carried out such that the pitch becomes lower, the tremolo unit is returned to its original position due to elastic force of the coil spring, and in the case where tuning is such that the pitch becomes higher, the tremolo unit is returned to its original position by the string tension.

The knife edge and the V groove component are both made of metal, and both are pressed intensely in contact with each other due to the tension of the string and the coil spring. Accordingly, when the tremolo unit is inclined, both the knife edge and the V groove slide against each other and wear progresses, thus causing surface roughening and the like, and wear adhesion occurs and frictional resistance is thereby increased. As a result, the movement of the tremolo unit is no longer smooth and when the tremolo arm is moved away after choking, the tremolo unit is unable to return all the way back to its proper position, and the problem is caused that the pitch is shifted from that of the initial tuning.

Furthermore, there is also the problem that the structural components of the peg also wear. In general, the peg includes a worm gear having a knob fixed to one end portion thereof, and a worm wheel having a winding shaft fixed to one end portion thereof. The worm gear and the worm wheel are on the body which is mounted to the head of the guitar, and are in mesh with each other. In addition, the worm gear and the shaft receiver thereof, the worm wheel and the shaft receiver thereof, and the main body are in contact with each other, and these portions are intensely pressed to each other due to string tension. Accordingly, when tuning is carried out and the knob is rotated, the sliding of the components is intense, and as a result surface roughening occurs and the adhesion wear of the metal occurs causing the frictional resistance to increase. Consequently, the peg does not rotate smoothly and this not only hinders tuning, but in the worse case, the components bite into each other and become inoperable.

The sliding portions of the peg may be coated with oil or grease as a lubricant. However, these types of lubricants do not stay only at the portions where they are needed but rather flow away or deteriorate naturally and thus the effect thereof cannot be maintained. Also, the wooden portion of the guitar becomes greasy and there is the problem that this detracts from the aesthetic appearance and also has a negative impact on the tone.

As described above, rusting and wearing of the components that slide against the string and other components have a great negative impact on the pitch and on the ability of the guitar to be tuned. This leads directly to deterioration of the properties that can be considered to define the guitar. In spite of this fact, up until now, no consideration has been given to controlling the progress of rusting and wear of the metal components. Thus, the object of the present invention is to provide metal components for a stringed instrument in which rusting and corrosion of the metal components is prevented, and in which frictional resistance of the components due to sliding against each other is decreased, and these components can be kept in a state in which they can slide smoothly with respect to each other over a long period of time.

### SUMMARY OF THE INVENTION

Fluorine resins have excellent water resistance and have a low friction coefficient. The present invention pays close attention to these properties of fluorine resins, and it was seen that by plating the metal components of a stringed instrument using a nickel plating solution having fluorine resin particles dispersed therein, the effect of preventing rusting became extremely favorable. Also, excellent lubricating properties were exhibited even when there was intense sliding of the metal components against each other.

The metal components for a stringed instrument of the present invention were achieved based on the information presented in the foregoing. For the metal components for a stringed instrument which slide against the surfaces of the string and other components, at least the portions thereof which slide against other portions are provided with a lubricating solid coating containing a fluorine resin mixture.

The fluorine resin is preferably one in which a polyacetal resin contains at 10% by weight or more of polytetrafluoroethylene (abbreviated as PTFE hereinafter). The proportion of PTFE in the lubricating solid coating is preferably 6-14% by weight (or 20-40% by volume). Also, in view of design, it may be desirable that there be a choice with respect to color and luster of each of the components; thus, the surface of the lubricating solid coating may be chrome plated. The chrome plating is preferably micro-crack chrome plating having minute cracks evenly dispersed therein. The water resistance is maintained by the lubricating solid undercoat beneath the cracks being exposed. In addition, if the chrome plating wears, the undercoat portion that is exposed increases, and thus, the lubricating property as well as the water resistance also increase. It is to be noted that black chrome may also be used for chrome plating.

It is preferable that heat treatment be carried out after the lubricating solid coating is chrome plated. By carrying out the heat treatment, the underlying fluorine resin seeps out to the surface through the cracks in the in the chrome plating. As a result, water resistance and lubricating property are both increased.

The present invention can be applied to all metal components which slide against the surface of the string and other components. This invention applies to any of the above-mentioned saddle, the bridge and components of the string height adjusting mechanism and the string length adjusting mechanism, the knife edge of the tremolo unit, the base plate of the tremolo unit and the support member which supports the base plate so as to be inclinable, the nuts, the string press, the shaft receiver of the winding shaft of the peg, the worm wheel and the peg body which contacts therewith, and the shaft receiver of the worm gear, as well as to other parts having a portion which slides against the string or other components.

In addition, in the case where the tailpiece is provided as a separate body from the bridge towards the rear thereof, the tailpiece is moved in the vertical direction to thereby adjust the tension of the string. The guitar is structured in this manner so that fine tuning can be carried out. In this case, a female screw is embedded into the body and the tailpiece which is supported by the screw is moved vertically by turning a screw which engages with the female screw. In this type of structure, the female screw and the screw, as well as the screw and the tailpiece, slide against each other. As a result, there is a problem that the sliding property deteriorates due to rusting. Thus the present invention also applies to the tailpiece and the components of the mechanism for the vertical movement thereof.

The following is a description of the method for manufacturing the metal components for a stringed instrument of the present invention.

1. Pre-treatment

The lubricating solid coating is plated, and prior to the plating, the materials are pre-treated. In the pre-treatment, water washing and acid washing to remove rust, as well as acid immersion for activation, is carried out.

2. Undercoat

In order to carry out tone adjustment, plating with a nickel undercoat or the like is carried out. The undercoat is not limited to nickel, and copper plating may be used as well. Furthermore, nickel plating may be carried out after the undercoating, or alternatively, it may be carried out in place of the undercoating in order to obtain desired luster. In this nickel plating, by dispersing metal particles in the plating solution, surface conditions such as half luster, lacquer, hair line and the like may be obtained.

3. Nickel/PTFE Plating

The lubricating solid coating is carried out using an electro-less or an electrolytic plating. In an electro-less plating, the examples of the nickel salt which is a source of the nickel ions are nickel sulfate and nickel hypophosphite. Examples of the pH adjuster include ammonium chloride and sodium hydroxide (alkaline solutions) or lactic acid (acidic solution). In addition, PTFE particles having an average particle diameter of 1 μm or less are added to the above mixture.

In the electro-plating nickel sulfamate (400-450 g/l) and nickel chloride (40-50 g/l) are generally used as the nickel salt. The pH adjuster is generally boric acid (35-45 g/l). It is to be noted that nickel sulfate may be used in place of the nickel sulfamate. Also, PTFE particles having an average particle diameter of 1 μm or less (25-50 g/l) are added to these. Also, in order to obtain a desired luster 8-12 ml/l of a luster agent is added.

The electrolytic plating is carried out by using a nickel ground metal with an anode, and an electric current is passed between the electrode and the metal component. At that time, the plating solution preferably has a temperature of 45-55°; a pH of 4.0-4.5; and a current density of 1-6 A/dm². In this type of electro-plating, nickel particles and PTFE particles are deposited on the surface of the metal component, and a lubricating solid coating formed of this mixture is formed.

4. Chrome Plating

A known method may be used for carrying out the chrome plating. For example, a plating solution having anhydrous chromic acid and sulfuric acid or sodium hydroxide as the main component may be used. It is to be noted that in order to carry out black chrome plating, sulfaminic acid and boric acid are used in place of sulfuric acid and sodium hydroxide.

5. Heat Treatment

The heat treatment to which metal components are subjected after the chrome plating is carried out, for example, by heating the metal components and maintaining the temperature at 300 to 400° C. (preferably 320-370°) for 30 to 120 minutes (preferably for 50 to 70 minutes).

### BRIEF EXPLANATION OF THE DRAWINGS

FIG. 1 is an assembly perspective view of a tremolo unit using the metal components of the first embodiment of the present invention.

FIG. 2 is an assembly perspective view of a tremolo unit using the metal components of a modified example of the first embodiment of the present invention.

FIG. 3 is an assembly perspective view of a tremolo unit using the metal components of another modified example of the first embodiment of the present invention.

FIG. 4 is an assembly perspective view of a tremolo unit using the metal components of yet another modified example of the first embodiment of the present invention.

FIG. 5 is an assembly perspective view of a tailpiece using the metal components of the second embodiment of the present invention.

FIG. 6 is an assembly perspective view of a bridge using the metal components of the third embodiment of the present invention.

FIG. 7 is an assembly perspective view of a bridge using the metal components of a modified example of the third embodiment of the present invention.

FIG. 8 is an assembly perspective view of a tremolo unit using the metal components of the fourth embodiment of the present invention.

FIG. 9 is an assembly perspective view of a tremolo unit using the metal components of a modified example of the fourth embodiment of the present invention.

FIG. 10 is an assembly perspective view of a peg using the metal components of the fifth embodiment of the present invention.

FIG. 11 is an assembly perspective view of a peg using the metal components of a modified example of the fifth embodiment of the present invention.

FIG. 12 is an assembly perspective view of a peg using the metal components of another modified example of the fifth embodiment of the present invention.

FIG. 13 is an assembly perspective view of a peg using the metal components of yet another modified example of the fifth embodiment of the present invention.

### BEST MODE FOR CARRYING OUT THE INVENTION

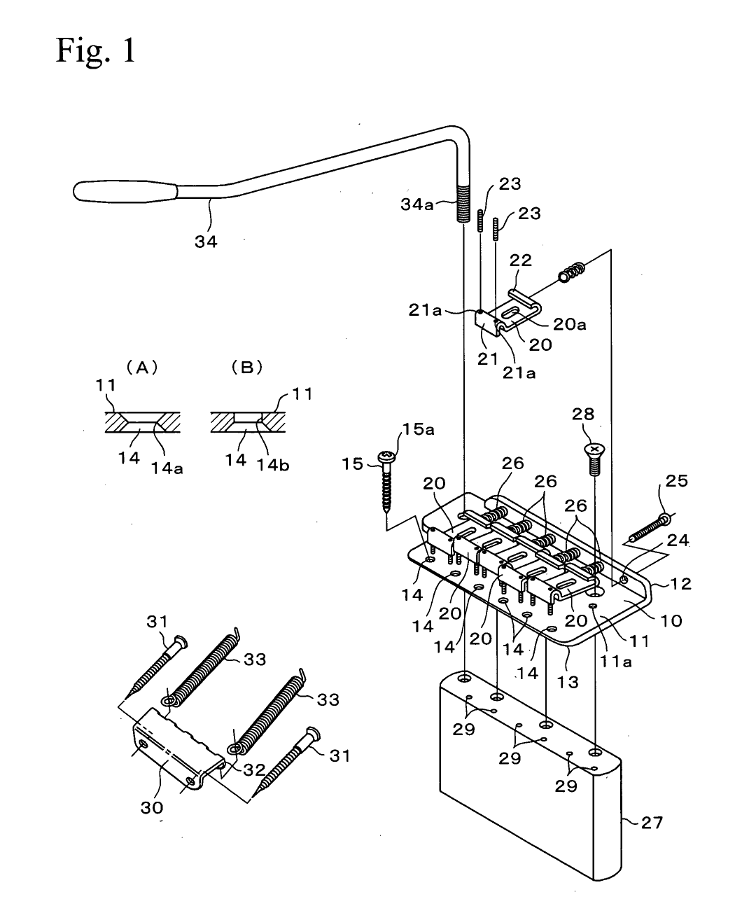

The embodiments of the preferred invention will be described with reference to FIGS. 1 through 13. It is to be noted that in the description below, the guitar body is horizontal and the neck side is considered to be the front end (front), and directions such as the vertical direction, the left-right direction (lateral direction) are indicated with the front end as a reference point.

1. First Embodiment

FIG. 1 is an assembly view of the tremolo unit of the first embodiment. In the drawings, reference numeral 10 is the base plate, and the base plate 10 comprises a base portion 11 which is provided substantially parallel with respect to the body of the electric guitar, and a support portion 12 which is erected vertically from the rear end portion of the base portion 11. The exterior of the base plate 10 is L-shaped. Six holes 11a, through which the strings are passed, is formed at a middle portion in the longitudinal direction of the base portion 11. In addition, a taper portion 13 which tapers toward the front, is formed at the front end portion of the lower surface of the base portion 11. Six holes 14 are formed so as form a straight line on the taper portion 13. As shown in FIG. 1 (A), at the central portion in the thickness direction of the hole 14, a knife edge 14a is formed by the base portion 11 being subjected to a countersinking process from the front and back surfaces thereof. It is to be noted that as shown in Fig. B, the countersinking process may be carried out from only the back surface of the base portion 11, thus forming a round edge 14b having a flat portion or an arc-shaped portion. In addition, a stud screw 15 which screws into the body, is inserted through the hole 14, and the cylinder shaped portion of the head portion 15a of the stud screw 15 engages with the knife edge 14a.

In FIG. 1, reference numeral 20 is the saddle, and corresponding to the number of strings, six saddles are disposed in the lateral direction of the stringed instrument. It is to be noted that the bridge is formed from these six saddles 20. The front end portion of the saddle 20 is bent into a U-shape so as to form a convexity in the upward direction. This portion is the vertical adjustment portion 21 for adjusting the position of the saddle 20 with respect to the base plate 10 in the vertical direction. Also, the rear end portion of the saddle 20 is bent in a U-shape so as to form a convexity towards the rear end. This portion is the longitudinal adjustment portion 22 for adjusting the position of the saddle 20 in the longitudinal direction. The screw hole 21a is formed in the vertical adjustment portion 21, and the vertical adjustment screw 23 is screwed therein. The lower end portion of the vertical adjustment screw 23 abuts the upper surface of the base plate 10, and by changing the dimension of protrusion of the vertical adjustment screw 23 from the vertical adjustment portion 21, the position of the saddle 20 with respect to the base plate 10 in the vertical direction can be adjusted. As a result, the strings can be disposed so as to have an arc configuration and the adjustment of the string height can be carried out from the fret.

Holes 24 which correspond to each of the saddles 20 are formed in the support portion 12 of the base plate 10, and the longitudinal adjustment screw 25 is inserted through each of the holes 24. The front end portion of the longitudinal adjustment screw 25 screws into the longitudinal adjustment portion 22 of the saddle 20. In addition, a coil spring 26 is attached to the longitudinal adjustment screw 25. As a result, the longitudinal adjustment portion 22 and the support portion 12 are biased so as to move away from each other. By turning the longitudinal adjustment screw 25, the saddle 20 moves in the longitudinal direction. It is to be noted that 20a is a hole through which the strings pass.

The tailpiece 27 is attached by the bolt 28 toward the rear end of the lower surface of the base plate 10. The tailpiece 27 is a rectangular block, and includes six holes 29 which penetrate the block in a vertical direction thereof. In addition, the string ball is engaged with the lower side opening of the hole 29 and the string which is inserted from this side is passed through the hole 11a of the base plate 10 and the hole 20a of the saddle 20. The peg is placed at the middle portion of the upper surface of the vertical adjustment portion 21 and tuning of the strings is thus carried out.

The tailpiece is disposed so as to face the opening which penetrates the guitar body and is provided on the back surface thereof. A bracket 30 is mounted at the rear of the opening in the body, using a screw 31. Also, one end portion of the coil spring 33 is mounted on the hook 32 of the bracket 30. The other end portion of the coil spring 33 is mounted on the lower surface of the tailpiece 27. In addition, the elastic force (pull tension) of the coil spring 33 acts on the lower end portion of the tailpiece 27, while the string tension acts in the opposite direction. In the drawings, 34 is the tremolo arm and the base plate 10 is mounted by the screw 34 which is formed at an end portion thereof.

The components of the tremolo unit having the above described structure are all formed of metal. Of these components, the present invention applies to: the base plate 10 (knife edge 14a), the stud screw 15, the saddle 20, the vertical adjustment screw 23, and the longitudinal adjustment screw 25. A lubricating solid coating is formed on the surface of these metal components by plating them with nickel and/or PTFE. Furthermore, decorative chrome plating and heat treatment is also carried out. The following is a description of the operation of these metal components.

First, in order to carry out choking while playing the guitar, the tremolo arm 34 is manipulated so that the tremolo unit is inclined forwards (or backwards). As a result, the strings move toward a nut (not shown) while it slides against the vertical adjustment portion 21 of the saddle 20. Also, when the tremolo arm 34 is moved away from the guitar, the tremolo unit returns to its original position due to the elastic force of the coil spring 33, and in that case also, the string slides against the saddle. In this case, because the saddle 20 is provided with a lubricating solid coating, the lubrication of the string is excellent and the wear of the saddle 20 is thus controlled. Accordingly, surface roughening of the saddle 20 or adhesion wear of the metal becomes difficult, and smooth return of the tremolo unit to its original position can be maintained over a long period of time. In addition, even if perspiration adheres to the saddle 20, poor operation of the tremolo unit due to rusting is prevented.

Next, in order to adjust the string height, the vertical adjustment screw 23 is turned and the length of protrusion downwards from the saddle 20 is changed. Also, in the case where the string length is adjusted in order to carry out fine tuning, the longitudinal adjustment screw 25 is turned and the saddle 20 is pushed out toward the front or pulled in toward the rear. Since these metal components are provided with a lubricating solid coating, even if perspiration is deposited on them, it is unlikely that they will rust. Thus, smooth turning of the vertical adjustment screw 23 and the longitudinal adjustment screw 25 can be maintained and adjustment can be easily carried out.

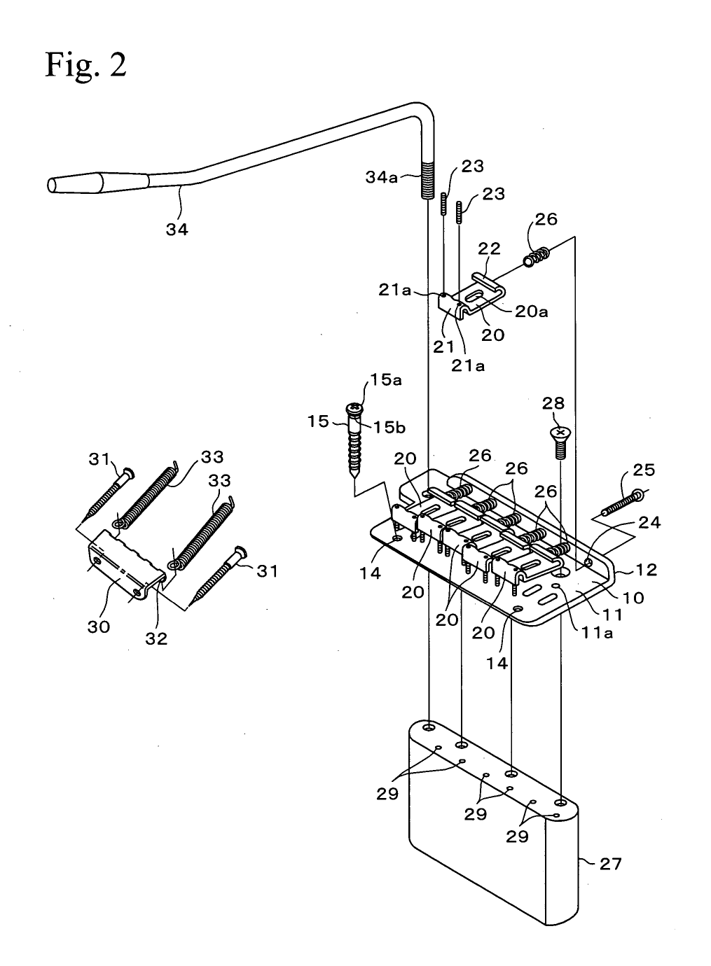

Next, modified examples of the first embodiment of the above-described first embodiment will be described with reference to FIG. 2. It is to be noted that in the description below, structural elements which are the same as those shown in FIG. 1 are assigned the same numbers, and descriptions thereof are omitted. The only differences between the modified example shown in FIG. 2 and the embodiment shown in FIG. 1 are: the stud screw 15 is provided at two locations which are at both end portions in the lateral direction of the base plate 10; and a groove 15b having a V-shaped cross section is formed along the entire periphery of the neck portion which is directly beneath the head portion 15a of the stud screw 15. This modified example achieves the same operations and effects as that of the embodiment shown in FIG. 1. Specifically, in this modified example, the groove 15b of the stud screw 15 is forcefully abraded by the knife edge 14a of the base plate 10. However, since both components are coated with a lubricating solid, they have excellent lubricating properties, and thus wear is controlled. It is to be noted that in the first embodiment, both of the components which slide against each other are provided with the lubricating solid coating. However, the object of the present invention is achieved if only one of the components is provided with the lubricating solid coating. The same also applies to the other embodiments of the present invention which are described below.

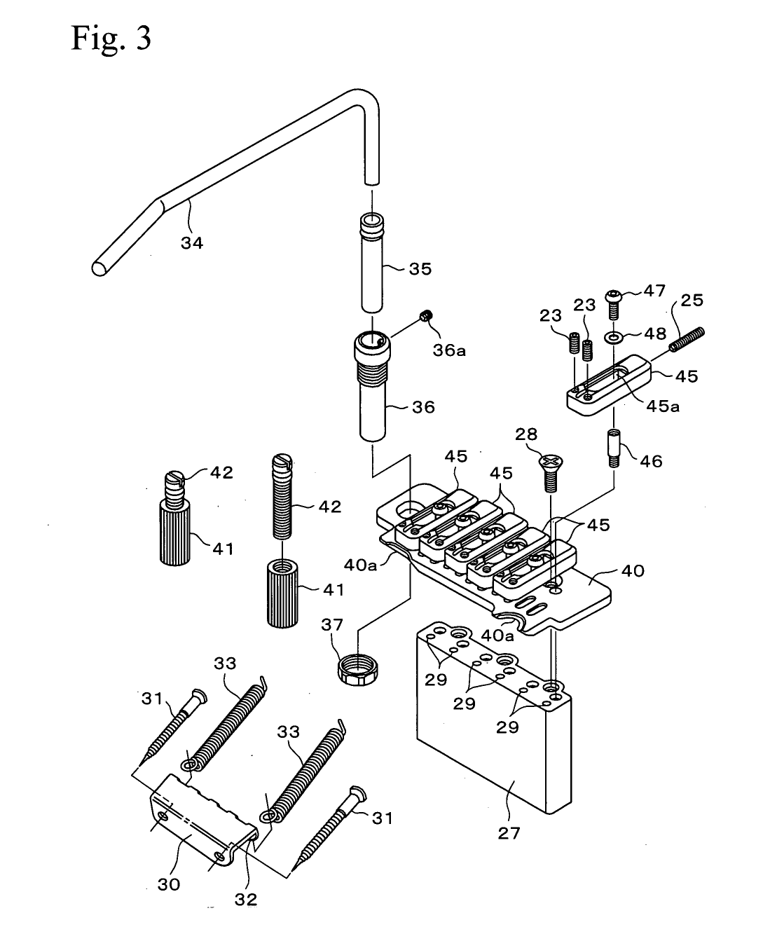

FIG. 3 shows another modified example of the first embodiment. In this modified example, a knife edge 40a is formed at both side portions of the front end edges of the base plate 40. Also, an anchor nut 41 is press-inserted into the body of the guitar, and a stud bolt 42 screws into the anchor nut 41. The neck portion directly beneath the head portion 42a of the stud bolt 42 has a V-shaped groove 42b formed along its entire periphery, and the knife edge 40a engages with the groove 42b.

In the drawings, reference numeral 45 is the saddle and a long hole 45a is formed in the middle portion of the saddle 45. The guide pin 46 is inserted through the long hole 45a, and the lower end portion of the guide pin 46 passes through the base plate 40 and screws into the upper end surface of the tailpiece 27. A fixing screw 47 screws into an upper end portion of the guide pin 46, and the saddle 45 is fixed by being tightened with the fixing screw 47 via the washer 48. It is to be noted that the longitudinal adjustment screw 25 shown in FIG. 3 passes through the long hole 45a from the rear end portion of the saddle 45 and is thereby screwed into the saddle 45. The front end portion of the saddle 45 abuts the side portion of the guide pin 46. Also, reference numeral 36 is the arm holder, and the arm holder 36 is mounted to the base plate 40 by the nut 37. An arm bushing 35 engages with the arm holder 36 and is fixed by the machine screw 36a. The base end portion of the tremolo arm 34 is press-inserted into the arm bushing 35.

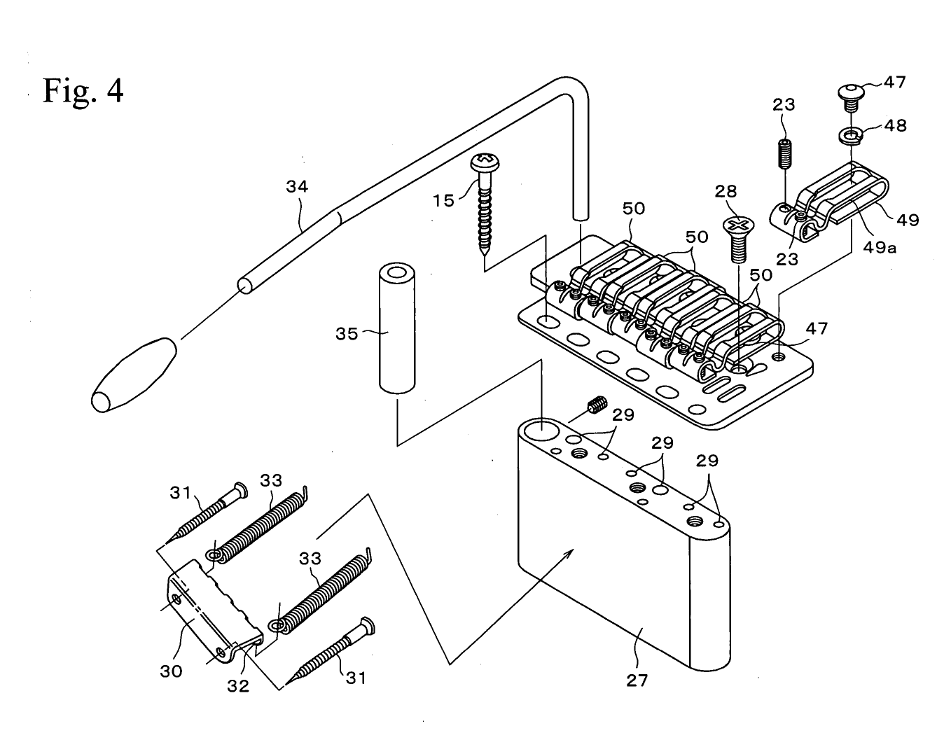

In this modified example, the metal components to which the present invention pertains are the base plate 45 (knife edge 45a), the stud bolt 42, the saddle 45, the vertical adjustment screw 23, the longitudinal adjustment screw 25, and the guide pin 46. A lubricating solid coating is formed on the surface of these metal components by plating them with nickel and/or PTFE. Furthermore, decorative chrome plating and heat treatment is also carried out, and as a result, the same operations and effects as those of the first embodiment are achieved. It is to be noted that FIG. 4 shows a modified example in which the saddle 49 is formed of a sheet-like material, and the long hole 49a which is formed in the saddle 49 guides the shaft of the fixing screw 47.

2. Second Embodiment

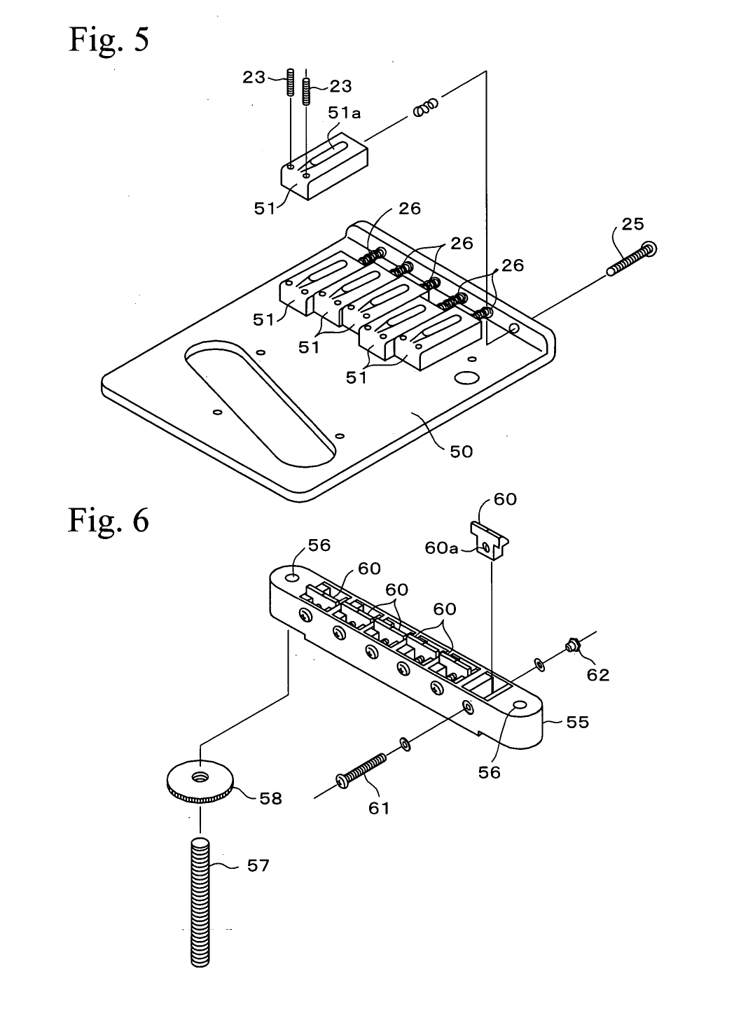

The second embodiment of the present invention will be described with reference to FIG. 5. FIG. 5 shows a bridge, and this bridge is formed such that a plurality of saddles 51 are aligned on the base plate 50 in the lateral direction thereof. On this bridge, the string passes through the hole 51a formed in the middle portion of the saddle 51, and a tailpiece which is the same as that of the first embodiment is fixed thereto. In this second embodiment, the metal components to which the present invention pertains are the saddle 51, the vertical adjustment screw 23, the longitudinal adjustment screw 25, and the base plate 50 which slides against the saddle 51. A lubricating solid coating is formed on the surface of these metal components by plating them with nickel and/or PTFE. Furthermore, decorative chrome plating and heat treatment is also carried out, and as a result, the same operations and effects as those of the first embodiment are achieved.

3. Third Embodiment

FIG. 6 shows the bridge of the third embodiment of the present invention. A tailpiece, which is not shown, is mounted to the rear side of this bridge. The ball of the string which is wound on the bridge engages with this tailpiece. In FIG. 3, reference numeral 55 is the bridge body, and holes 56 are formed in both end portions thereof. On the other hand, a screw 57 is mounted in the body of the guitar, and the upper end portion of the screw 57 fits into the hole 56. An underslung washer 58 which supports the bridge body 55 is screwed onto the upper end portion of the screw 57. As a result of this structure, the bridge body 55 moves in the vertical direction when the underslung washer 58 is turned, and the string height can be thereby adjusted.

The saddle 60 is accommodated at the bridge body 55 so as to be movable in the vertical and longitudinal directions. A screw hole 60a which penetrates the saddle 60 in the longitudinal direction is formed therein, and a rotatable longitudinal adjustment screw 61 which penetrates the bridge body 55 in the longitudinal direction fits into the screw hole 60a. Thus, by rotating the longitudinal adjustment screw 61, the saddle 60 moves in the longitudinal direction. It is to be noted that 62 is the nut that prevents the longitudinal adjustment screw 61 from coming out from the hole.

In this third embodiment, the metal components to which the present invention pertains are the saddle 60, the screw 57, the washer 58, the longitudinal adjustment screw 61 and the bridge body 55 which slides against the saddle 60. A lubricating solid coating is formed on the surface of these metal components by plating them with nickel and/or PTFE. Furthermore, decorative chrome plating and heat treatment is also carried out, and as a result, the same operations and effects as those of the above-described embodiments are achieved.

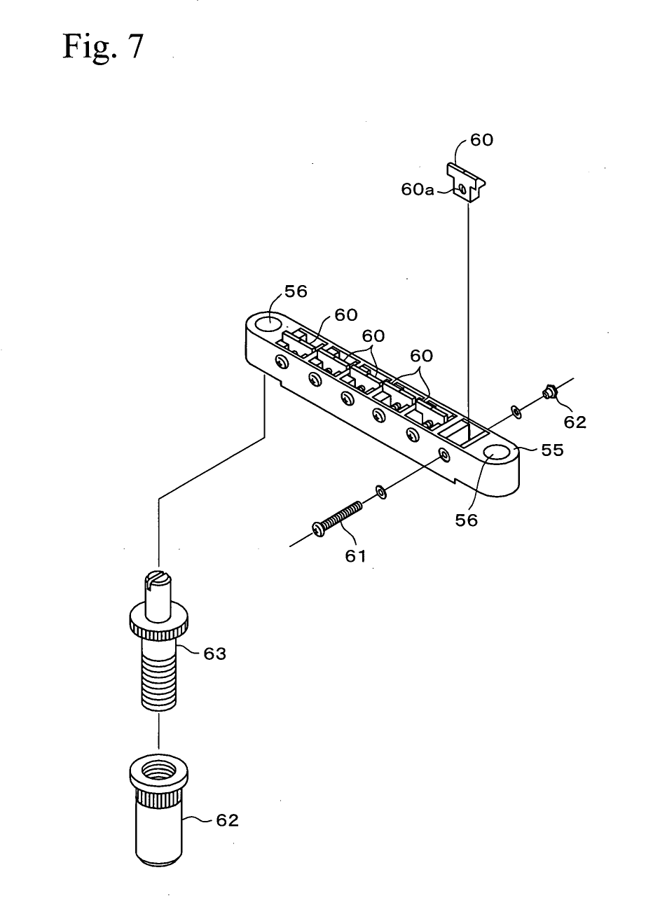

It should be noted that in FIG. 7, the bolt 57 and the washer 58 of the third embodiment are replaced with the anchor nut 62 and the flanged bolt 63, and that the same operations and effects of the third embodiment are achieved. Also, in the third embodiment, a tailpiece is disposed toward the rear of the bridge. However the tailpiece may be made movable in the vertical direction by using the same means as that used in the third embodiment for moving the bridge in the vertical direction. In that case, the present invention may also be applied to the tailpiece and to the metal components of the mechanism for the vertical movement thereof.

4. Fourth Embodiment

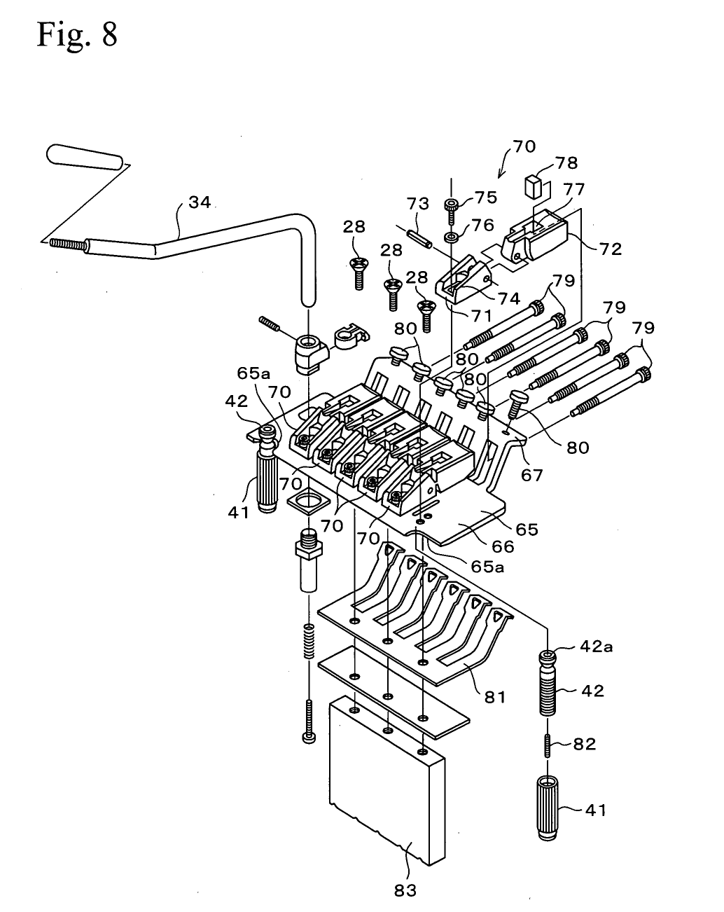

The tremolo unit of the fourth embodiment will be described with reference to FIG. 8. It is to be noted that in the description below, the focus will be on those aspects that are different from the tremolo unit shown in FIG. 3. The structural elements which are the same as those of FIG. 3 will be assigned the same numbers, and descriptions thereof will be omitted. In FIG. 8, reference numeral 65 is the base plate and the base plate 65 includes a base portion 66 at the front end thereof and a support portion 67 which inclines upward from the rear end edge of the base portion 66, and is extendable. Reference numeral 65a is a knife edge.

Six saddle units 70 are provided in the lateral direction of the base plate 65 so as to be disposed adjacent to each other. The saddle unit 70 has a schematic structure such that the fixing block 71 and the saddle 72 are joined together by the hinge 73. A long hole 74 which extends in the longitudinal direction is formed in the fixing block 71, and a fixing bolt 75 which screws into the base plate 65 is inserted through the long hole 74. The fixing block 71 is secured and fixed to the base plate 65 via the washer 76 with the fixing bolt 75.

A groove 77 which is open at the top is formed in the saddle 72, and the rear end portion of the string is inserted through this groove. A piece 78 which locks the string is inserted into the groove 77. A tightening bolt 79 extends into the groove 77 and screws into the rear end portion of the saddle 72, and at the front end portion thereof, the piece 78 is press-inserted in toward the front. As a result, the rear end portion of the string is nipped between the piece 78 and the inner wall of the groove 77, and is thereby fixed. That is to say, the saddle 72 also has the function of the tailpiece.

A vertical adjustment screw 80 whose lower end portion presses the tightening bolt 79, screws into the support portion 67 of the base plate 65. In addition, the spring plate 81 which presses the tightening bolt 79 upward is provided at the lower side of the base plate 65. The structure is as such because when the vertical adjustment screw 80 is tightened and the tightening bolt 79 is pressed down, the saddle 72 swings downward from the hinge 73, and the position of the portion of the saddle 72 which supports the string moves along with the saddle 72. As a result, the string tension is increased and the pitch becomes high. It is to be noted that the plate spring 81 supports the tightening bolt 79 and vibration is controlled.

As shown in FIG. 8, a screw hole 42a for height adjustment is formed in the stud bolt 42, and the upper end portion of the fixing screw 82 screws into the screw hole 42a. The stud bolt 42 is screwed into the anchor nut 41 which is press-inserted into the body of the guitar in a state in which the fixing screw 82 is inserted through. Due to this structure, when a wrench is inserted from the screw hole 42a of the stud bolt 42 and the fixing screw 82 is rotated, the fixing screw 82 moves upwards and abuts the bottom of the anchor nut 41. In addition, when the fixing screw 82 is further rotated, the stud bolt 42 also attempts to move upwards along with the fixing screw 82. As a result, the outer periphery screw surface of the stud bolt 42 and the inner periphery screw surface of the anchor nut 41 forcefully contact each other and are thereby fixed. Accordingly, by rotating the stud bolt 42 in a state in which the fixing screw 82 is loose, the position of the knife edge 65a in the vertical direction can be adjusted. Also, this state can be fixed by using the fixing screw 82. It is to be noted that 83 is a block, and the block 83 is different from the tailpiece 27 shown in FIG. 3 in that it does not engage with the string ball.

In this fourth embodiment, the metal components to which the present invention applies are the base plate 65 (the knife edge 65a), the fixing block 71, the saddle 72, the pin 73, the fixing bolt 75, the piece 78, the tightening bolt 79, the vertical adjustment screw 80, and the stud bolt 42. These are the metal components to which perspiration is likely to adhere and thus easily rust. Alternatively, they may be metal components which wear due to forceful sliding against other components. When these metal components rust and wear and surface roughening and the like occurs, it becomes impossible for the tremolo unit to operate smoothly, and thus fine adjustment of the string height and the like cannot be carried out. Thus a lubricating solid coating is formed on the surface of these metal components by plating them with nickel and/or PTFE. Furthermore, decorative chrome plating and heat treatment is also carried out, and as a result, the same operations and effects as those of the embodiments described above are achieved.

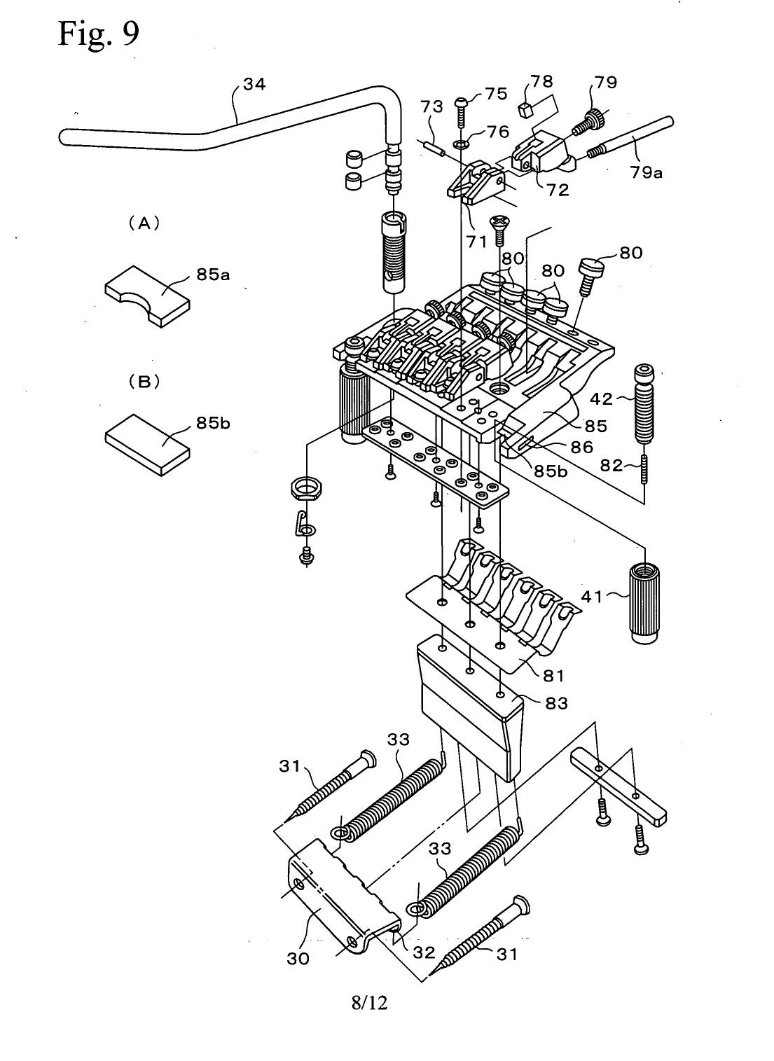

FIG. 9 is a modified example of the fourth embodiment. A push pin 79a at the lower side of the tightening bolt 79, is screwed into the rear end portion of the saddle 72. This push pin 79a can be pushed up by the vertical adjustment screw 80. Also, the base plate 85 is formed of a zinc and lead alloy. At the right side of the front end edge of the base plate 85, the knife edge 85a shown in (A) is inserted to the inner side from the insertion opening 86, while at the left side thereof, the knife edge 85b shown in (B) is inserted to the inner side from the insertion opening 86. In this modified example, the lubricating solid coating is provided to the knife edges 85a and 85b rather than to the base plate 65.

5. Fifth Embodiment

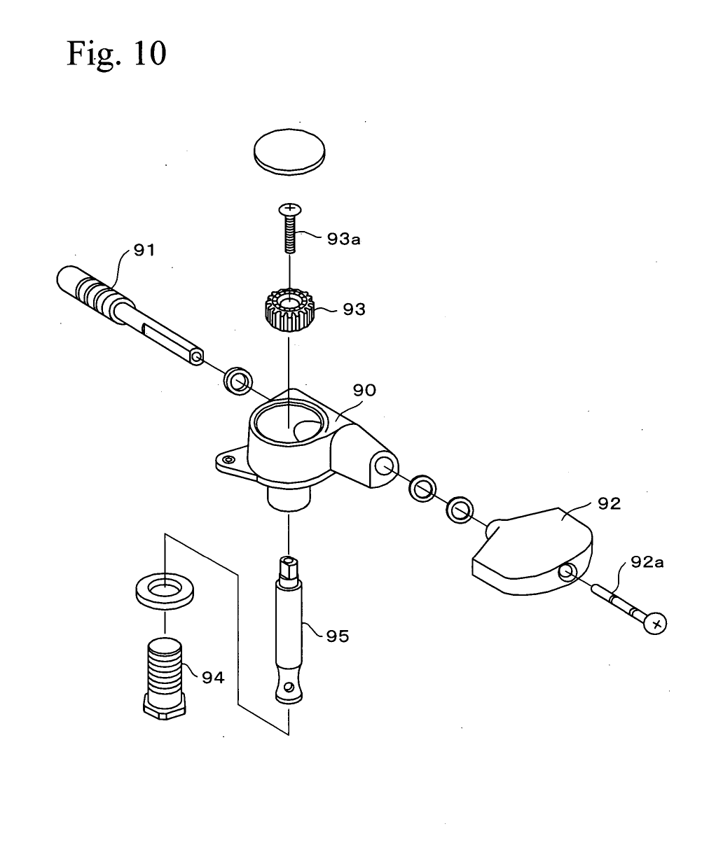

FIG. 10 shows the fifth embodiment of the present invention, and is an example in which the present invention is applied to a peg. In the drawing, reference numeral 90 is the casing which is mounted to the guitar head. The worm gear 91 is rotatably supported at the casing 90, and the end portion of the worm gear 91 extends from the casing 90, and a knob 92 is mounted to this extended portion with a screw 92a. In addition, a worm wheel 93 which meshes with the worm gear 91 such that its axis is in the direction in which it crosses the worm gear 91, is accommodated at the casing 90. The axle receiver 94 screws together with the casing 90, and the axle receiver 94 supports the winding shaft 95 so that it is rotatable. An end portion of the winding shaft 95 is mounted to the worm wheel 93 with a screw 93a.

In the peg having the above-described structure, by rotating the knob 92, the worm gear 91 rotates and the worm wheel 93 and the winding shaft 95 also rotate along with the worm gear 91. At this time, the bottom surface of the worm wheel 93, and the worm gear 91, slide against the inner surface of the housing 90, and the winding shaft 95 slides against the shaft receiver 94. In this fifth embodiment, the metal components to which the present invention applies are the housing 90 and the shaft receiver 94. These metal components are in forceful contact with the related components due to string tension, and thus, when the knob 92 is rotated, the components slide against each other forcefully. A lubricating solid coating is formed on the surface of these metal components by plating them with nickel and/or PTFE. Furthermore, decorative chrome plating and heat treatment is also carried out, and as a result the lubricating property is improved and problems such as stripping and adhesion wear of the metal are avoided. Accordingly, in a peg having the metal components of this embodiment, it is unnecessary to coat the sliding portions with oil or grease; thus, the problems of grease and the like flowing away or deteriorating naturally, or that of wooden components being damaged because they become greasy, are solved.

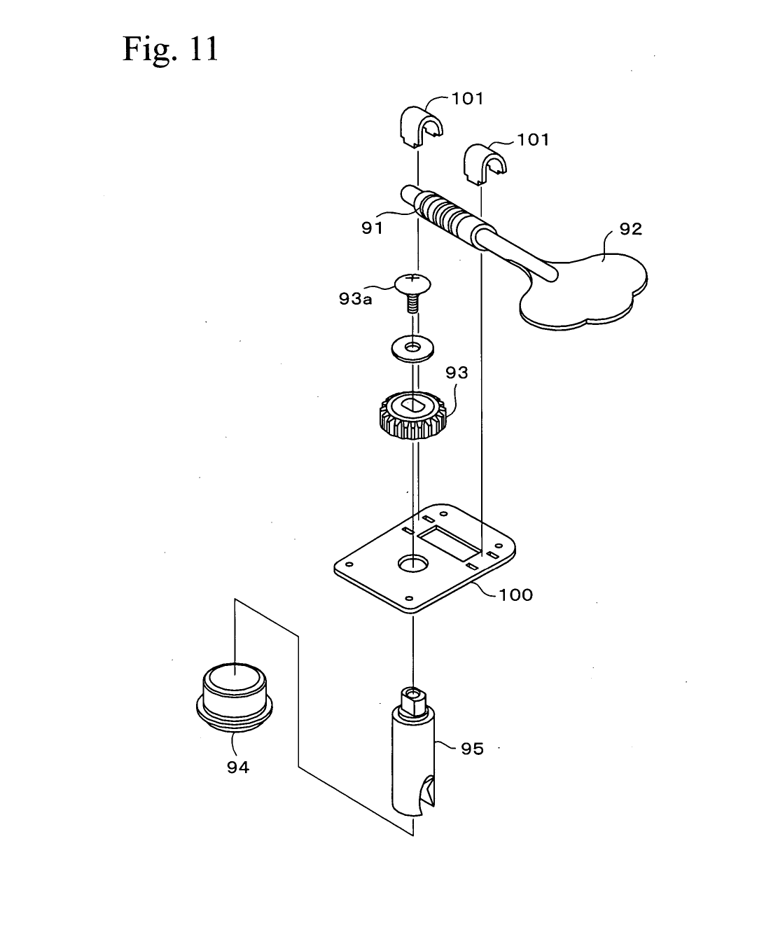

FIG. 11 shows a modified example of the fifth embodiment, and the peg shown in this drawing includes a plate-like main body 100, and a worm gear 91 is integrally formed with the knob 92 and is rotatably supported by a pair of shaft receivers 101 which are fixed by caulking to the main body 100. By applying the present invention to the main body 100 and the axle receivers 94 and 101, the same operations and effects as those of the above-described embodiment can be obtained.

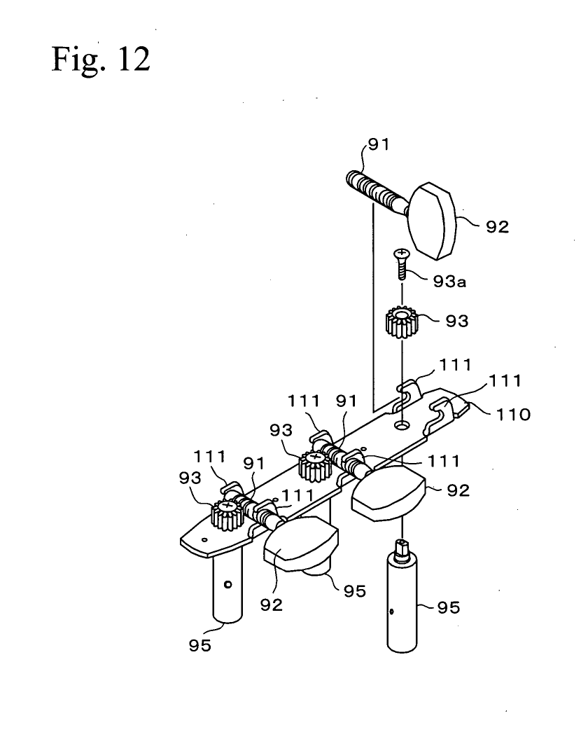

FIG. 12 shows another modified example of the fifth embodiment, and the peg shown in this figure includes a plate like main body 110 which is formed integrally with the pair of shaft receivers 111 and which rotatably supports the worm gear 91 which is formed integrally with the knob 92 at the shaft receivers 111. In this modified example, the end surface of the winding shaft 95 and the bottom surface of the worm wheel 93 slide against the main body 110. By applying the present invention to the main body 110 and the shaft receivers 111, the same operations and effects as those of the above-described embodiment can be achieved.

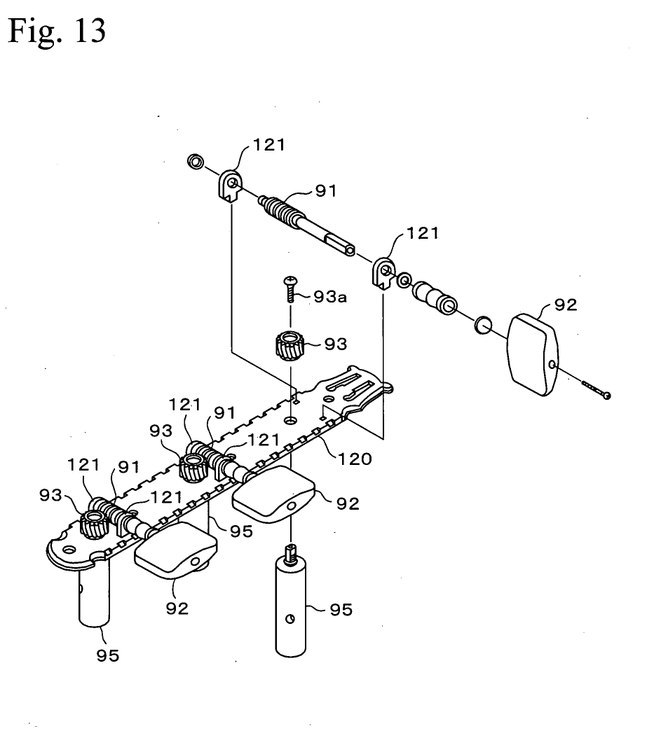

FIG. 13 shows yet another modified example of the fifth embodiment, and the peg shown in this figure includes a plate-like main body 120. A worm gear 91 is rotatably supported by a pair of shaft receivers 121 which are fixed by caulking to the body 120. In this modified example also, the end surface of the winding shaft 95 and the bottom surface of the worm wheel 93 slides against the main body 120. By applying the present invention to the main body 120 and the shaft receiver 121, the same effects as those of the above-described embodiment can be achieved.

It is to be noted that in this embodiment also, although the nut, and the string press which is provided between the nut and the peg, are not shown in these examples, by providing the nickel/PTFE plating thereto, the same effects as those of the above-described examples can be achieved. Also, recently, an electric guitar has been provided which includes a lock nut in which a pressure pad is placed on top of the nut, and this is tightened with a bolt in the direction of the nut, thereby locking the string. If the pressure pad and the bolts which are components of this type of lock nut rust as a result of perspiration adhering thereto, it is conceivable that the bolt will become unmovable. Thus, the present invention may also be applied to the lock nut. In addition, the fluorine resin is not limited to PTFE, and various resins may be suitably selected, provided that they include fluorine.

Furthermore, the present invention may be applied to all stringed instruments including acoustic guitars, electric guitars, and electric/acoustic guitars, base guitars, mandolins, ukuleles and the like.

According to the above-described present invention, because at least those portions of the string and the metal components for a stringed instrument which slide against other components are provided with a lubricating solid coating including a mixture of nickel and a fluorine resin, rusting and corrosion caused by sweat adhering to those components is prevented. Also, the frictional resistance due to the components sliding against each other is reduced, and metal components for a stringed instrument which can slide smoothly over a long period of time are obtained.

What is claimed is:

1. A metal component for a stringed instrument which slide against the strings or against other components, wherein, at least the sliding portions are coated with a lubricating solid comprising a mixture of nickel and a fluorine resin.

2. A metal components for a stringed instrument of claim 1, wherein the fluorine resin includes polytetrafluoroethylene.

3. A metal components for a stringed instrument of claim 1 wherein the surface of the lubricating solid coating is chrome plated.

4. A metal components for a stringed instrument of claim 3, wherein after chrome plating, heat treatment is carried out so that the polytetrafluoroethylene seeps into the chrome plated surface.

5. A metal components for a stringed instrument of claim 1, wherein any of: a saddle, a bridge and components of a string height adjusting mechanism or a string length adjusting mechanism; a knife edge of a tremolo unit; a base plate of a tremolo unit and a support member which supports the base plate so as to be inclinable; a tailpiece and components of a mechanism for vertical movement of the tailpiece; a nut and lock member which works together with the nut to lock the strings; a string press; a shaft receiver of a peg; a peg main body which contacts a worm wheel; and a shaft receiver of a worm which is provided coaxially with a knob, includes a portion that slides against the string or other component of the stringed instrument.
